(19) United States
(12) Patent Application Publication
(10) Pub. No.: US 2026/0115588 A1
(43) Pub. Date: Apr. 30, 2026

(54) SERVER AND NON-TRANSITORY STORAGE MEDIUM

(71) Applicant: TOYOTA JIDOSHA KABUSHIKI KAISHA, Toyota-shi (JP)

(72) Inventors: Yuki SOGABE, Nagoya-shi (JP); Sayaka YANAGAWA, Nagoya-shi (JP); Maki OKADA, Nagoya-shi (JP)

(73) Assignee: TOYOTA JIDOSHA KABUSHIKI KAISHA, Toyota-shi (JP)

(21) Appl. No.: 19/344,880

(22) Filed: Sep. 30, 2025

(30) Foreign Application Priority Data
Oct. 3, 2024 (JP) 2024-174608

(51) Int. Cl. A63F 13/27; G06F 3/14

(52) U.S. Cl. CPC A63F 13/27; G06F 3/14

(57) ABSTRACT

A server includes one or more processors configured to: send and receive information; upon receiving a request for character information on at least one character among one or more characters from a terminal device of a user, send the character information to the terminal device on a condition that the request meets a predetermined condition, the character information being acquired by the terminal device as the terminal device reads a sign or as the terminal device receives information from the sign, and the sign being installed at least one of inside a facility other than a user's seat or installed outside the facility; and cause the terminal device to output an image or a voice of the at least one character based on the character information.

### CROSS-REFERENCE TO RELATED APPLICATION

This application claims priority to Japanese Patent Application No. 2024-174608 filed on October 3, 2024. The disclosure of the above-identified application, including the specification, drawings, and claims, is incorporated by reference herein in its entirety.

### BACKGROUND

### 1. Technical Field

The present disclosure relates to a server and a non-transitory storage medium.

### 2. Description of Related Art

Technologies that help enhance spectators' enjoyment in watching an event have been proposed. For example, Japanese Unexamined Patent Application Publication No. 2024-17815 (JP 2024-17815 A) discloses a technology in which, when a near-field communication (NFC) tag sheet attached to a seat in an event venue is read by a terminal, a web link that provides various information is acquired by the terminal.

### SUMMARY

The related art merely uniformly performs information provision, thus leaving room for enhancing enjoyment in events.

The present disclosure provides a server device etc., that can further enhance the enjoyment of spectators of an event.

A server device according to a first aspect of the present disclosure includes one or more processors configured to: send and receive information; upon receiving a request for character information on at least one character among one or more characters from a terminal device of a user, send the character information to the terminal device on a condition that the request meets a predetermined condition, the character information being acquired by the terminal device as the terminal device reads a sign that is installed inside a facility at a place other than a user's seat or installed around the facility, or as the terminal device receives information from the sign; and make the terminal device output an image or a voice of the at least one character based on the character information.

A server device according to a second aspect of the present disclosure includes one or more processors configured to: send and receive information; upon receiving a request for character information from a terminal device of a spectator, send the character information to the terminal device on a condition that the request meets a predetermined condition, the character information being information on a character corresponding to a sign that is installed inside a venue at a place other than a spectator's seat or installed around the venue.

A non-transitory storage medium storing instructions that are executable by one or more processors and that are executed by the one or more processors using a terminal device, the non-transitory storage medium includes: that the terminal device sends a request for character information on a character corresponding to a sign that is installed inside a venue at a place other than a spectator's seat or installed around the venue to a server device; and that the terminal device displays an image of the character using the character information that is sent from the server device on a condition that the request meets a predetermined condition.

The server etc., in the present disclosure can further enhance the enjoyment of spectators of an event.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view showing an example of a configuration of an information processing system;

FIG. 2 is a sequence chart showing an example of an operation procedure of the information processing system; and

FIG. 3 is a flowchart showing an example of an operation procedure of a server device.

### DETAILED DESCRIPTION OF EMBODIMENTS

An embodiment will be described below with reference to the drawings.

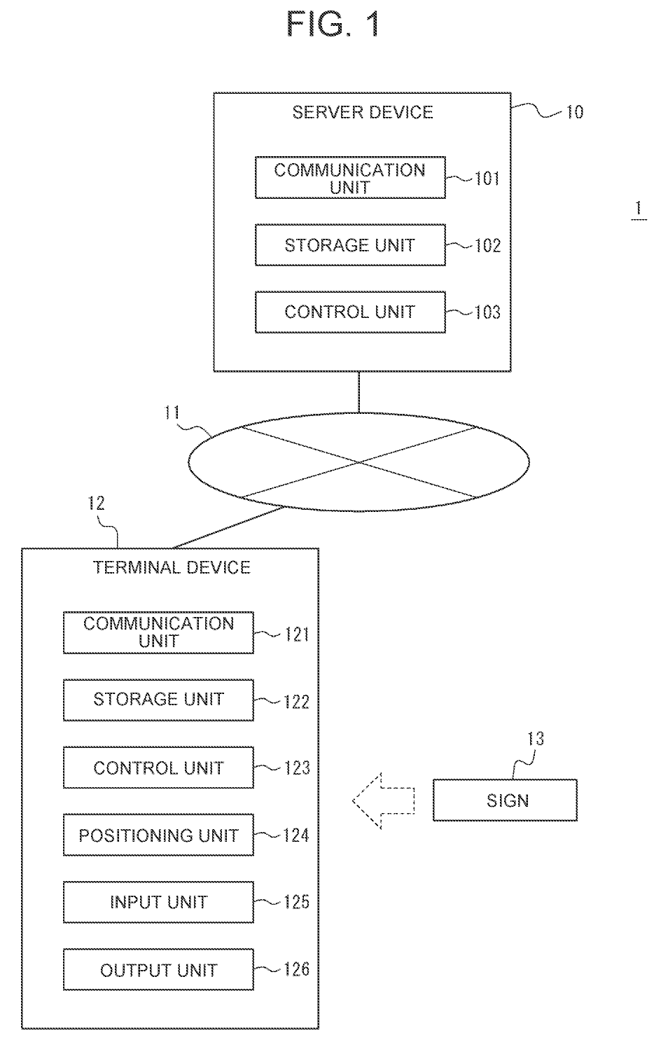

FIG. 1 is a view showing an example of a configuration of an information processing system in one embodiment. An information processing system 1 has one or more server devices 10 and one or more terminal devices 12 that are connected to each other through a network 11 so as to be able to communicate information. The server device 10 is, for example, a server computer that belongs to a cloud computing system or another computing system and functions as a server equipped with various functions. The terminal device 12 is an information processing terminal that exchanges various information with the server device 10, and is, for example, a smartphone or a tablet terminal device. The network 11 is, for example, the Internet, with other examples including an ad hoc network, a local area network (LAN), a metropolitan area network (MAN), other networks, and combinations of some of them.

In this embodiment, the information processing system 1 performs information provision for enhancing the enjoyment of spectators (users) who watch an event, through the terminal devices 12 that the spectators use. The event is an event in which a plurality of characters appears, with examples including events of animation, manga, games, popular culture, and sports, and is held in a venue (a facility), such as an exhibition hall or a stadium. The characters are, for example, characters appearing in contents, such as animation, manga, or games, or members of sport teams. The characters may be actual persons or may be fictitious persons or creatures. The characters may be characters that appear in the event to be held or may be characters that do not appear in it. Each of spectators who participate in the event is highly likely to have his or her favorite character. The server device 10 provides each spectator with information on his or her favorite character through the terminal device 12 of the spectator. Specifically, when the server device 10 receives, from the terminal device 12 of the spectator, a request for information on a character (hereinafter referred to as "character information") corresponding to a sign 13 that is installed inside the venue at a place other than a spectator's seat or installed around the venue, the server device 10 sends the character information to the terminal device 12 on the condition that the request meets predetermined conditions. The sign 13 that is installed inside the venue at a place other than the spectator's seat or installed around the venue may be a two-dimensional code, such as a bar code or a QR code (R), that is attached to a wall or a signboard, or may be a transmitter, such as a beacon. As the spectator manipulates the terminal device 12 to read the two-dimensional code or receive a radio signal from the transmitter, the terminal device 12 acquires access information, for example, URL information, for a website relating to the event (hereinafter referred to as an "event site") that the server device 10 provides. When the terminal device 12 accesses the event site, the server device 10 sends, to the terminal device 12, the character information according to conditions such as the timing, the installation position of the sign, and eligibility for participation in the event (hereinafter referred to as "provision conditions"). The character information is information about some characters, for example, one character of all the characters relating to the event. The terminal device 12 outputs an image or a voice of the character included in the character information toward the spectator. That the server device 10 sends the character information according to the provision conditions to the terminal device 12 can enhance the enjoyment of the spectator to such a level as would not be achieved by uniform information provision. On the other hand, when the acquired character information is not the information on his or her favorite character, to obtain the information on his or her favorite character in the venue, the spectator tries to acquire the character information while looking for a further sign 13. Thus, the spectator, on his or her part, can further enhance the enjoyment.

Next, an example of a configuration of the server device 10 will be described.

The server device 10 has a communication unit 101, a storage unit 102, and a control unit 103. The server device 10 may be one computer, or may be composed of two or more computers that are connected to one another so as to be able to communicate information and that operate in a coordinated manner. When the server device 10 is composed of two or more computers, the configuration shown in FIG. 1 is disposed in the two or more computers as appropriate.

The communication unit 101 includes one or more communication interfaces. The communication interface is, for example, an LAN interface. The communication unit 101 receives information to be used for the operation of the control unit 103, and transmits information obtained by the operation of the control unit 103. The server device 10 is connected to the network 11 by the communication unit 101, and performs information communication with the terminal device 12 via the network 11.

The storage unit 102 includes, for example, a main storage device, an auxiliary storage device, or one or more semiconductor memories, one or more magnetic memories, or one or more optical memories that function as a cache memory, or a combination of at least two types among them. The semiconductor memory is, for example, a random access memory (RAM) or a read only memory (ROM). The RAM is, for example, a static RAM (SRAM) or a dynamic RAM (DRAM). The ROM is, for example, an electrically erasable programmable ROM (EEPROM). The storage unit 102 stores information to be used for the operation of the control unit 103 and information obtained by the operation of the control unit 103.

The control unit 103 includes one or more processors, one or more dedicated circuits, or a combination of them. The processor is, for example, a general-purpose processor, such as a central processing unit (CPU), or a special-purpose processor, such as a graphics processing unit (GPU), that is specialized for specific processing. The dedicated circuit is, for example, a field-programmable gate array (FPGA), an application specific integrated circuit (ASIC), or the like. The control unit 103 executes information processing relating to the operation of the server device 10 while controlling each unit of the server device 10.

The function of the server device 10 is realized as the processor included in the control unit 103 executes a control program. The control program is a program that causes a computer to execute a process of a step included in the operation of the server device 10 to thereby cause the computer to realize a function corresponding to the process of that step. Thus, the control program is a program that causes the computer to function as the server device 10. Some or all of the functions of the server device 10 may be realized by the dedicated circuit included in the control unit 103. The control program may be stored in a non-transient recording-storage medium that is readable by the server device 10, and the server device 10 may read the control program from that medium.

Next, an example of a configuration of the terminal device 12 will be described.

The terminal device 12 has a communication unit 121, a storage unit 122, a control unit 123, a positioning unit 124, an input unit 125, and an output unit 126.

The communication unit 121 includes a communication module etc., compatible with a wired or wireless LAN standard, a mobile communication standard, or a near-field communication standard. Examples of mobile communication standards include Long-Term Evolution (LTE), 4th Generation (4G), and 5th Generation (5G). Examples of near-field communication standards include NFC, Bluetooth, Wi-Fi Direct, ZigBee, infrared communication, and radio-frequency identification (RFID). The terminal device 12 is connected to the network 11 by the communication unit 121 through a nearby router device or a base station of mobile communication. The terminal device 12 performs information communication with another device via the network 11, as well as performs information communication with a beacon installed as the sign 13 in the venue by near-field communication.

Examples of the storage unit 122 include one or more semiconductor memories, one or more magnetic memories, one or more optical memories, and combinations of at least two types among them. The semiconductor memory is, for example, an RAM or an ROM. The RAM is, for example, an SRAM or a DRAM. The ROM is, for example, an EEPROM. The storage unit 122 functions as, for example, a main storage device, an auxiliary storage device, or a cache memory. The storage unit 122 stores information to be used for the operation of the control unit 123 and information obtained by the operation of the control unit 123.

Examples of the control unit 123 include one or more processors, one or more dedicated circuits, and combinations of them. The processor is a general-purpose processor, such as a CPU, or a special-purpose processor specialized for specific processing. The dedicated circuit is, for example, an FPGA or an ASIC. The control unit 123 executes information processing relating to the operation of the terminal device 12 while controlling each unit of the terminal device 12.

The positioning unit 124 includes one or more global navigation satellite system (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioning unit 124 sends a positioning result to the control unit 123, and the control unit 123 determines position information on the terminal device 12.

The input unit 125 includes one or more input interfaces. Examples of input interfaces include a microphone that accepts a voice input, a physical key, a capacitive key, a pointing device, and a touch screen provided as integral with a display. Further examples of input interfaces include a camera and a scanner for reading a two-dimensional code. The input unit 125 accepts manipulation for inputting information to be used for the operation of the control unit 123 and reads a two-dimensional code installed as the sign 13 in the venue, and sends the information thus input to the control unit 123.

The output unit 126 includes one or more output interfaces. The output interface is, for example, a speaker or a display. The display is, for example, a liquid crystal display (LCD) or an organic electro-luminescence (EL) display. The output unit 126 outputs information obtained by the operation of the control unit 123.

The functions of the control unit 123 are realized as the processor included in the control unit 123 executes a control-processing program. The control-processing program is a program that causes a computer to execute a process of a step included in the operation of the control unit 123 and thereby causes the computer to realize a function corresponding to the process of that step. Thus, the control-processing program is a program that causes the computer to function as the control unit 123. Some or all of the functions of the control unit 123 may be realized by a dedicated circuit included in the control unit 123.

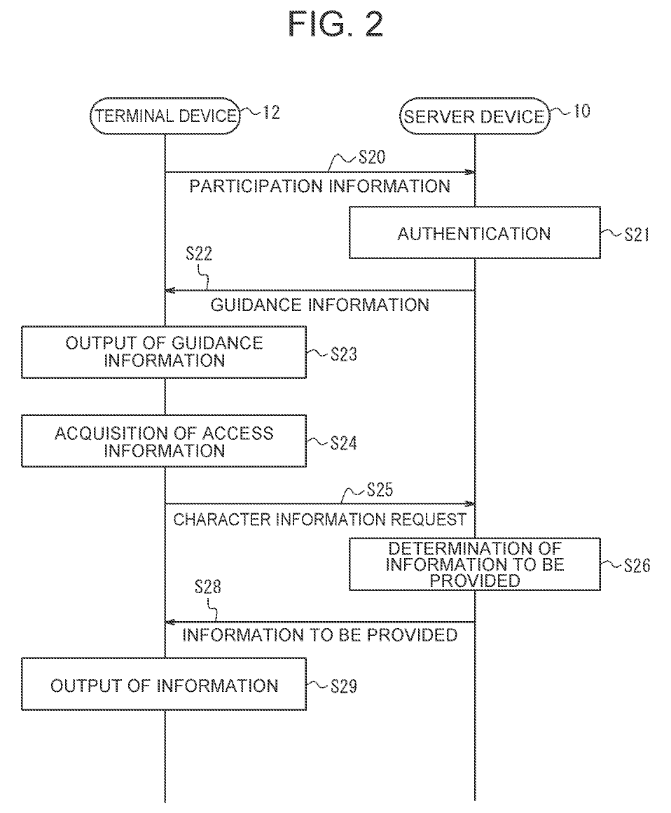

FIG. 2 is a sequence chart for describing an operation procedure of the information processing system 1 in this embodiment. FIG. 2 shows a procedure for the coordinated operation of the server device 10 and the terminal device 12. Steps relating to various information processing of the server device 10 and the terminal device 12 in FIG. 2 are executed by their respective control units 103, 123. Steps relating to sending and receiving various information of the server device 10 and the terminal device 12 are executed as their respective control units 103, 123 send and receive information to each other through the communication units 101, 121, respectively. In the server device 10 and the terminal device 12, the control units 103, 123, respectively, store the information to be sent and received in the storage units 102, 122, respectively, as appropriate. Further, the control unit 123 of the terminal device 12 accepts an input of various information from the spectator by the input unit 125 or accepts information from the sign 13, and outputs various information toward the spectator by the output unit 126.

The example of the procedure of FIG. 2 is an example of the procedure that is executed when the spectator participates in an event.

In S20, the terminal device 12 sends participation information to the server device 10. The participation information includes identification information on the spectator, information specifying the event, etc., that are acquired when the spectator signs up for the event. For example, the participation information is sent from the terminal device 12 to the server device 10 as the spectator manipulates the terminal device 12 to access the event site, specify the event that the spectator will watch, and input identification information, such as an ID and a password.

In S21, the server device 10 performs authentication of the spectator. The server device 10 authenticates the spectator by checking an event application record against the participation information and determining whether the identification information on the spectator is included in the application record.

In S22, the server device 10 sends guidance information to the terminal device 12. The guidance information is, for example, a map image of the event venue showing places where the signs 13 are installed in the event venue. The server device 10 sends the guidance information to the terminal device 12 on the condition that the authentication of the spectator succeeds. The server device 10 may send the guidance information to the terminal device 12 on the condition that the authentication succeeds. This can contribute to mitigating congestion before the start of the event. The server device 10 may send the guidance information to the terminal device 12 on the condition that a time to start time of the event is shorter than an arbitrary reference time (a few tens of minutes to a few hours). Setting the reference time to a certain time or longer can contribute to mitigating congestion before the start of the event.

In S23, the terminal device 12 outputs the guidance information. The terminal device 12 displays the guidance information to present it to the spectator. By viewing the guidance information, the spectator can recognize the positions of the signs 13 in the venue of the event that the spectator will watch.

Arriving at the event venue, the spectator looks for the signs 13 using the guidance information.

In S24, the terminal device 12 acquires access information. The access information is information for accessing the character information on the character corresponding to each sign 13, and includes identification information on the sign 13 or information showing the installation position thereof in the venue. The character information is provided, for example, on the event site. Upon finding one of the signs 13, the spectator manipulates the terminal device 12 to acquire the access information corresponding to the sign 13. For example, when the sign 13 is a two-dimensional code, the terminal device 12 acquires the access information as the terminal device 12 reads the two-dimensional code. Alternatively, when the sign 13 is a transmitter, the terminal device 12 acquires the access information as the terminal device 12 receives a signal including the access information from the transmitter by near-field communication. At the stage of acquiring the access information from the sign 13, the spectator does not know whether the character information that is made accessible by that access information is that on his or her favorite character or on another character.

In S25, the terminal device 12 sends a request for the character information to the server device 10. The spectator sends the request for the character information to the server device 10 by manipulating the terminal device 12. Using the access information, the terminal device 12 generates a request asking for character information that is accessible by the access information, and sends the request to the server device 10. The request includes the identification information or the installation position information on the sign 13.

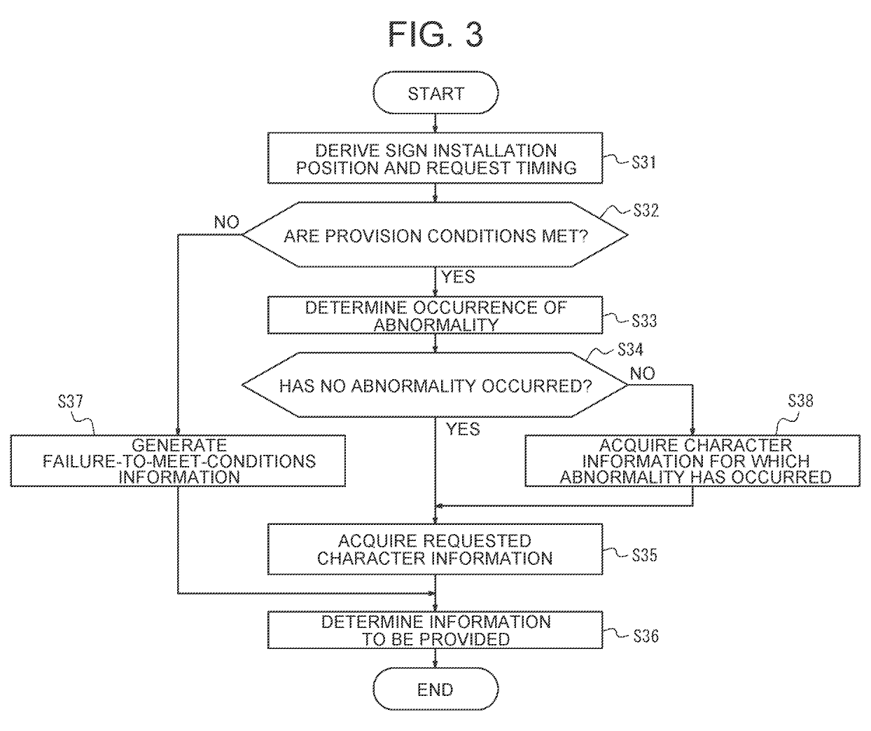

In S26, the server device 10 determines information to be provided to the terminal device 12. A detailed procedure of step S26 is shown in FIG. 3.

FIG. 3 is a flowchart showing an example of the procedure that is executed by the control unit 103 of the server device 10.

In S31, the control unit 103 derives the installation position of the sign 13 and the timing when the character information request was sent. The control unit 103 derives the installation position of the sign 13 using the information showing the installation position of the sign 13 that is sent from the terminal device 12. The installation position of the sign 13 is classified, for example, as inside the venue and outside a spectators' seating area, or as outside the venue. The control unit 103 derives the timing of the request based on, for example, a time stamp at the time of receiving the request. The timing of the request is classified as before the start of the event, during the event, after the event, etc. The control unit 103 derives the timing of the request by, for example, acquiring event schedule information that is stored in the storage unit 102 beforehand and checking an event schedule against the time stamp of the request.

In S32, the control unit 103 determines whether the provision conditions are met. The provision conditions are conditions for providing the requested character information in response to a request for character information from the terminal device 12. The provision conditions include, for example, a condition about the timing of the request and a condition about the installation position of the sign 13. The provision conditions are met, for example, in the following cases 1) to 3):

1) The timing of the request is before the start of the event and the installation position of the sign 13 is inside the venue and outside the spectators' seating area.

2) The timing of the request is before the start of the event and the installation position of the sign 13 is outside the venue.

3) The timing of the request is after the end of the event and the installation position of the sign 13 is outside the venue.

The above does not include that the timing of the request is during the event and that the installation position of the sign 13 is in the spectators' seating area, which can encourage the spectator to focus on the event.

The provision conditions include, for example, authentication information on the sign 13 and authentication information on a ticket for the event. The provision conditions are met, for example, in the following case 4):

4) The authentication information on the sign 13 matches the authentication information on the ticket for the event.

In the above, the right to request character information is granted only to spectators who have a ticket to the event, which allows the spectators to avoid excessive congestion in the venue.

When the provision conditions are met (Yes) in S32, the control unit 103 proceeds to step S33, and when the provision conditions are not met (No), the control unit 103 proceeds to step S37 and generates failure-to-meet-conditions information. The failure-to-meet-conditions information includes a statement for notifying the spectator that the character information will not be provided due to failure to meet the provision conditions.

In S33, the control unit 103 performs determination on occurrence of an abnormality in the signs 13. When it is inferred that one or more signs 13 have been damaged, taken away, etc., such that spectators cannot access the characters corresponding to these signs 13, the control unit 103 determines that an abnormality has occurred. The control unit 103 acquires, from the storage unit 102, a history of requests that were received from one or more terminal devices 12 in the past, and derives a list of the characters corresponding to these requests. For example, the storage unit 102 stores beforehand the character information on the respective characters corresponding to each event in a state of each being associated with the identification information or the installation position information on the corresponding sign 13. The control unit 103 derives a request frequency of each character in an arbitrary past period (e.g., a few hours before a current time to the current time) and identifies a character for which the number of times of request is zero. In this case, it is inferred that an abnormality has occurred in the sign 13 for requesting the character information on that character. In this way, the control unit 103 determines occurrence of an abnormality.

When the control unit 103 determines in S34 that no abnormality has occurred (Yes), the control unit 103 proceeds to step S35, and when the control unit 103 does not determine that no abnormality has occurred (No), the control unit 103 proceeds to step S38.

In S35, the control unit 103 acquires the requested character information. The control unit 103 acquires the requested character information by selecting and reading the character information corresponding to the requested character from the storage unit 102.

On the other hand, in S38, the control unit 103 acquires the character information for which the abnormality has occurred. The character information for which the abnormality has occurred is the character information on the character corresponding to the sign 13 in which occurrence of an abnormality has been determined. The control unit 103 identifies the sign 13 in which the abnormality has occurred, and reads and acquires the character information associated with the identification information or the installation position information on that sign 13 from the storage unit 102.

In S36, the control unit 103 determines information to be provided. The control unit 103 determines, as the information to be provided, the requested character information, or the requested character information and the character information for which an abnormality has occurred. Alternatively, when the provision conditions are not met, the control unit 103 determines the failure-to-meet-conditions information as the information to be provided.

Then, the control unit 103 ends the procedure of FIG. 3.

Returning to FIG. 2, in S28, the server device 10 sends the information to be provided to the terminal device 12.

In S29, the terminal device 12 outputs the information to be provided that has been received from the server device 10. For example, the terminal device 12 outputs the character information on the requested character. The character information includes a still image, a moving image, or a voice of the character. In addition to the character information on the requested character, the terminal device 12 outputs the character information on the character for which an abnormality has occurred. Thus, the spectator can obtain the character information that has become inaccessible. Alternatively, the terminal device 12 outputs the failure-to-meet-conditions information. Thus, the spectator gets a motivation to look for another sign 13.

By the procedure as described above, the character information is provided to the spectator. When the provided character information is on his or her favorite character, the spectator can get stimulation of enjoyment. In that case, for example, by storing the character information in the storage unit 102 of the terminal device 12, the spectator can access the favorite character information at any time. On the other hand, when the provided character information is not on his or her favorite character, the spectator gets a motivation to look for another sign 13. Then, the spectator can obtain another character information that is requested based on another sign 13. In this way, the enjoyment of looking for until reaching the character information on one's favorite character is aroused.

The character information includes information that specifies an aspect in which the character is displayed. The character is displayed, for example, as a moving image, and can utter a message relating to the event etc. For example, the character is presented to the spectator as the terminal device 12 displays a text, such as "Welcome to event X" or "Look forward to my doing X in today's event," or outputs it as a voice. The character information may include information for superimposing an image of the character on a captured image when imaging by the terminal device 12. For example, when the spectator takes a memorial photo of himself or herself, the character is inserted next to his or her own image. Thus, the spectator can experience the enjoyment of augmented reality (AR).

In a modified example, when the timing of the request is after the start of the event and the installation position of the sign 13 is outside the venue in step S35 of FIG. 3, the server device 10 changes the aspect of presentation of the character information. In the storage unit 102, information on aspects of presentation of each character information has been stored beforehand. For example, an aspect of presentation suitable after the end of the event is selected. The aspect of presentation suitable after the end of the event is, for example, an aspect in which a character utters a message expressing gratitude for watching the event, and in which a message such as "Thank you for coming" or "Thank you for rooting for me" is displayed or output as a voice. Thus, even after the end of the event, the spectator continues to get stimulation of enjoyment by looking for the signs 13 outside the venue and around the venue.

The aspect of the sign 13 can be changed according to the popularity of the corresponding character. For example, a two-dimensional code corresponding to a more popular character can be displayed in a smaller size or in a more inconspicuous color or design to thereby enhance the enjoyment of the spectators in looking for the signs 13.

One sign 13 may correspond to a plurality of characters. The terminal device 12 of a first user can receive the character information corresponding to a first character corresponding to one sign 13 from the server device 10 on the premise that an arbitrary condition is met. The terminal device 12 of a second user can receive the character information corresponding to the first character or the character information on a second character different from the first character from the server device 10. The order in which the character information on a plurality of characters is provided may be random or may be an arbitrarily specified order.

In the above-described embodiment, the spectators, on their part, can further enhance the enjoyment.

The embodiment has been described above based on the drawings and examples. Note that a person skilled in the art can easily perform various modifications and alterations based on the present disclosure. Accordingly, it is noted that the modifications and the alterations are included in the scope of the present disclosure. For example, functions and others included in means, steps, and others can be reallocated such that there is no logical inconsistency, and a plurality of means, steps, and others can be combined into one, or can be divided.

What is claimed is:

1. A server comprising one or more processors configured to:
send and receive information;
upon receiving a request for character information on at least one character among one or more characters from a terminal device of a user, send the character information to the terminal device on a condition that the request meets a predetermined condition, the character information being acquired by the terminal device as the terminal device reads a sign or as the terminal device receives information from the sign, and the sign being installed at least one of inside a facility other than a user's seat or installed outside the facility; and
cause the terminal device to output an image or a voice of the at least one character based on the character information.

2. A server comprising one or more processors configured to:
send and receive information; and
upon receiving a request for character information from a terminal device of a spectator, send the character information to the terminal device on a condition that the request meets a predetermined condition, the character information being information on a character corresponding to a sign that is installed inside a venue other than a spectator's seat or installed outside the venue.

3. The server according to claim 2, wherein the one or more processors are configured to send guidance information showing a position of the sign to the terminal device before start time of an event held in the venue.

4. The server according to claim 2, wherein the sign is installed in the venue in an aspect according to a degree of popularity of the character corresponding to the sign.

5. The server according to claim 2, wherein the one or more processors are configured to send the character information on the character corresponding to a first sign in which occurrence of an abnormality has been determined to the terminal device configured to send the request for the character information on the character corresponding to a second sign.

6. The server according to claim 2, wherein the predetermined condition is that a timing when the request is sent is outside a running time of an event held in the venue.

7. The server according to claim 2, wherein the predetermined condition is that the request has been sent based on the sign that is installed inside the venue other than the spectator's seat.

8. The server according to claim 2, wherein the predetermined condition is that a timing when the request is sent is after end of an event held in the venue and that the request has been sent based on the sign that is installed outside the venue.

9. The server according to claim 8, wherein the character information that the one or more processors send to the terminal device is information showing a predetermined aspect of the character.

10. The server according to claim 2, wherein the character information is information for outputting one or both of an image and a voice of the character by the terminal device.

11. A non-transitory storage medium storing instructions that are executable by one or more processors and that cause the one or more processors to perform functions comprising:
sending, by a terminal device, a request for character information on a character corresponding to a sign that is installed inside a venue other than a spectator's seat or installed outside the venue to a server; and
displaying, by the terminal device, an image of the character using the character information that is sent from the server on a condition that the request meets a predetermined condition.

12. The functions according to claim 11, further comprising outputting, by the terminal device, guidance information showing a position of the sign that is sent from the server before start time of an event held in the venue.

13. The functions according to claim 11, wherein the sign is installed in the venue in an aspect according to a degree of popularity of the character corresponding to the sign.

14. The functions according to claim 11, further comprising outputting, by the terminal device, the character information on the character corresponding to a first sign in which occurrence of an abnormality has been determined, the character information being sent from the server in response to the terminal device sending the request for the character information on the character corresponding to a second sign.

15. The functions according to claim 11, wherein the predetermined condition is that a timing when the request is sent is outside a running time of an event held in the venue.

16. The functions according to claim 11, wherein the predetermined condition is that the request has been sent based on the sign that is installed inside the venue other than the spectator's seat.

17. The functions according to claim 11, wherein the predetermined condition is that a timing when the request is sent is after end of an event held in the venue and that the request has been sent based on the sign that is installed outside the venue.

18. The functions according to claim 17, wherein the character information that is sent from the server is information showing a predetermined aspect of the character.

19. The functions according to claim 11, wherein the character information is information for outputting one or both of the image and a voice of the character.

20. The functions according to claim 11, wherein the character information is information for adding the image of the character to a captured image.
